(19) United States
(12) Patent Application Publication
(10) Pub. No.: US 2010/0175504 A1
(43) Pub. Date: Jul. 15, 2010

(54) POWER MULTIPLIER

(76) Inventor: George Atanasoski, Ormond Beach, FL (US)

Correspondence Address: EDWARD M. LIVINGSTON, PA, 963 TRAIL TERRACE DRIVE, NAPLES, FL, 34103, US

(21) Appl. No.: 12/352,709

(22) Filed: Jan. 13, 2009

(51) Int. Cl. F16H 37/06

(52) U.S. Cl. 74/665 G

(57) ABSTRACT

A power multiplier (1) having a housing (2) which houses a gear assembly (20) having four gear sets (21, 22, 23, 24) each having input gears (8) affixed to each other by an off-set input axle (7), output gears (9) affixed to each other by an off-set output axle (11) and linkages (12) which connect the off-set input axles to the off-set output axles thereby allowing the input gears to transfer rotational force to the output gears The gear sets are connected to each other by central input axles (6) and central output axles (10). The placement of the off-set output and off-set input axles progressively differs by ninety degrees clockwise going from the first gear set to the fourth gear set. The placement of the off-set output and off-set input axles in this manner allows for an equal distribution of rotational force around the central output axles thereby creating additional torque.

### BACKGROUND OF THE INVENTION

This invention relates to devices for increasing the power output from an engine or motor, more particularly, a device which connects to a motor or engine, takes rotational power output from the motor or engine and increases the rotational power through the use of gear assembly thereby increasing torque, horsepower and overall power output.

The continuing increases in the cost of fuel and electricity, and increased environmental concerns have forced global attention on a variety of energy-conserving, and energy generating technologies. In the past, many extensive attempts have been made to achieve potential fuel and energy consumption savings for engines and motors. Currently, one device available is described in U.S. Pat. No. 5,632,548, issued as Mayfarth on May 27, 1997.

Although newer motors and engines are made to be more energy efficient, there is still room to improve on the efficiency of newer motors and engines. In addition, older motors and engines, which are still in use, are highly inefficient by present standards.

Therefore, a need exists for a power multiplier device which can increase the power output from an engine or motor and can easily be adapted to new or old engines and motors.

### SUMMARY OF THE INVENTION

The primary object of the present invention is to provide a power multiplier which increases the power output of an engine or motor.

Another object of the present invention is to provide a power multiplier which increases torque.

An even further object of the present invention is to provide a power multiplier which increases horsepower.

Another object of the present invention is to provide a power multiplier which may be easily adapted to new or old engines and motors.

The present invention fulfills the above and other objects by providing a power multiplier having a housing which houses a gear assembly made up of four gear sets with each gear set having two input gears affixed to each other by an off-set input axle, two output gears affixed to each other by an off-set output axle and a linkage which connects the off-set input axle to the off-set output axle. The linkage allows the input gears to transfer rotational force to the output gears. The gear sets are connected to each other by central input axles and central output axles. The placement of the off-set output axles and off-set input axles on the input gears and output gears progressively differs by ninety degrees, going clockwise from the first gear set to the fourth gear set, so that the placement of the off-set output axle and input axle is at 90 degrees in the first gear set, then the placement of the off-set output axle and off-set input axle is at 180 degrees in the second gear set, then the placement of the off-set output axle and off-set input axle is at 270 degrees in the third gear set and finally the placement of the off-set output axle and off-set input axle is at 360 degrees in the fourth gear set.

At a proximal end of the housing a central input axle extends to the outside of the housing through a ball bearing to form a power input connection which may be connected to a power source such as a motor or engine.

The placement of the off-set output axles and off-set input axles allows for an equal distribution of rotational force around the central output axles as well as equal revolutions per minute (“RPM”) between the input gears and the output ears. In addition, the output gears have a larger diameter than the input gears. The difference in diameter of the output gears and input gears along with the placement of the of the off-set output axles and off-set input axles in relation to the central axles gives a mechanical advantage which applies an increased rotational force to the central output axles thereby creating more torque which thereby increasing the horsepower of the power output from the power multiplier. The following formula which demonstrates torque in relationship to horsepower shows that as torques is increased, horsepower is also increased:

$$Horsepower = \frac{RPM \times Torque}{5252}$$

At a distal end of the housing a central output axle extends to the outside of the housing through a ball bearing to form a power output connection which may be connected to a power application such as machinery, generators which can power other devices and/or funnel energy back to the power source, or additional power multipliers to achieve additional power output.

Depending on the configuration of the gear assembly within the housing, the input power connection may have at least two intermeshing gears which transfer power from the input power connection to the gear assembly.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a top plan view of a power multiplier of the present invention having a lateral configuration;

FIG. 2 is a side perspective view of a gear assembly of a power multiplier of FIG. 1 showing the placement of off-set input axles, linkages and off-set output axles in relationship to each other;

FIG. 3 is a side plan view of a power multiplier of the present invention having a satellite configuration;

FIG. 4 is a front plan view of a gear assembly of a power multiplier of FIG. 3 showing the placement of off-set input axles, linkages and off-set output axles in relationship to each other;

FIG. 5 is a side perspective view of a gear assembly of a power multiplier of FIG. 3 showing the placement of off-set input axles, linkages and off-set output axles in relationship to each other; and

FIG. 6 is a diagram showing a power multiplier of the present invention in use.

### DESCRIPTION OF THE PREFERRED EMBODIMENTS

For purposes of describing the preferred embodiment, the terminology used in reference to the numbered components in the drawings is as follows:

| | |
|---|---|
| 1. | power multiplier |
| 2. | housing |
| 3. | proximal end |
| 4. | distal end |
| 5. | input connection |
| 6. | central input axle |
| 7. | off-set input axle |
| 8. | input gear |
| 9. | output gear |
| 10. | central output axle |
| 11. | off-set output axle |
| 12. | linkage |
| 13. | output connection |
| 14. | power application |
| 15. | ball bearing |
| 16. | input intermeshing gear |
| 17. | output intermeshing gear |
| 18. | power source |
| 19. | divider wall |
| 20. | gear assembly |
| 21. | first gear set |
| 22. | second gear set |
| 23. | third gear set |
| 24. | fourth gear set |
| 25. | 90 degree position |
| 26. | 180 degree position |
| 27. | 270 degree position |
| 28. | 360 degree position |
| 29. | 45 degree position |
| 30. | 135 degree position |
| 31. | 225 degree position |
| 32. | 315 degree position |

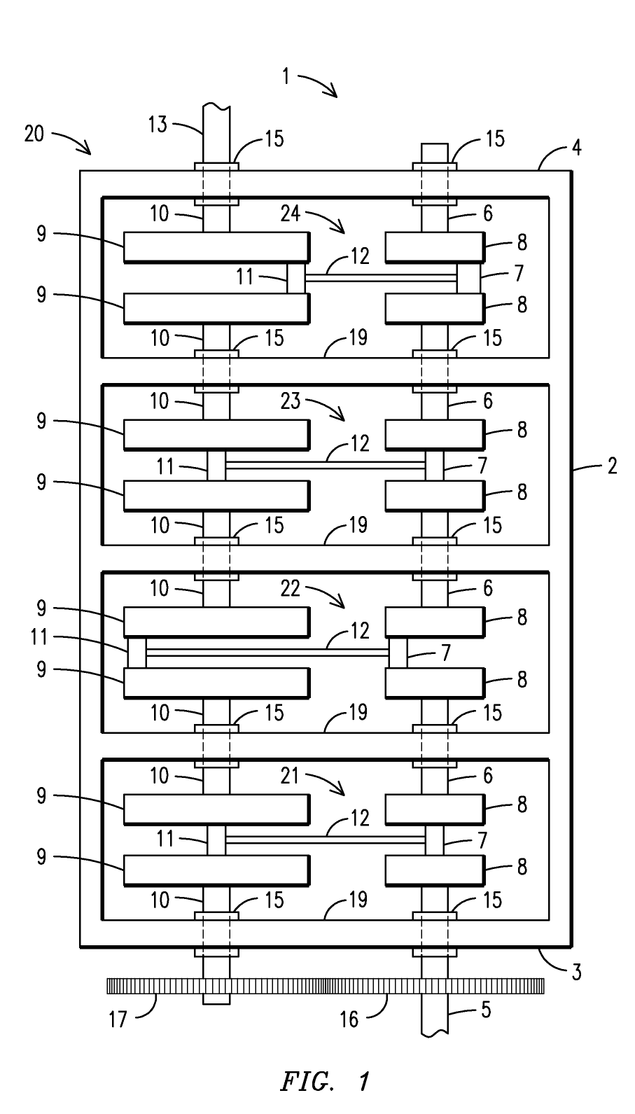

With reference to FIG. 1, a top plan view of a power multiplier 1 of the present invention having a lateral configuration is shown. The power multiplier 1 has a housing 2 which houses a gear assembly 20 made up of four gear sets 21, 22, 23, 24. Each gear set 21, 22, 23, 24 has two input gears 8 affixed to each other by an off-set input axle 7, two output gears 9 affixed to each other by an off-set output axle 11 and a linkage 12 which connects the off-set input axle 7 to the off-set output axle 11. The linkage 12 allows the input gears 8 to transfer rotational force to the output gears 9. The gear sets 21, 22, 23, 24 are divided by divider walls 19 of the housing 2. The gear sets 21, 22, 23, 24 are connected to each other by central input axles 6 and central output axles 10. The central input axles 6 and central output axles 10 pass through ball bearings 15 located in the housing 2 and the divider walls 19 of the housing.

At a proximal end 3 of the housing 2 a central input axle 6 extends to the outside of the housing 2 through a ball bearing 15 to form a power input connection 5 which may be connected to a power source 19 such as a motor or engine. The power supplied by the power source 18 rotates the gear assembly 20. A central output axle 10 extends through a ball bearing 15 at the proximal end 3 of the housing 2 and may be attached to an output intermeshing gear 17 which makes contact to an input intermeshing gear 16 which may be attached the central input axle 6 which extends to the outside of the housing 2 through a ball bearing 15.

At a distal end 4 of the housing 2 a central output axle 10 extends to the outside of the housing 2 through a ball bearing 15 to form a power output connection 13 which may be connected to a power application 14 such as machinery, generators which can power other devices and/or funnel energy back to the power source, or additional power multipliers to achieve additional energy output, and so forth.

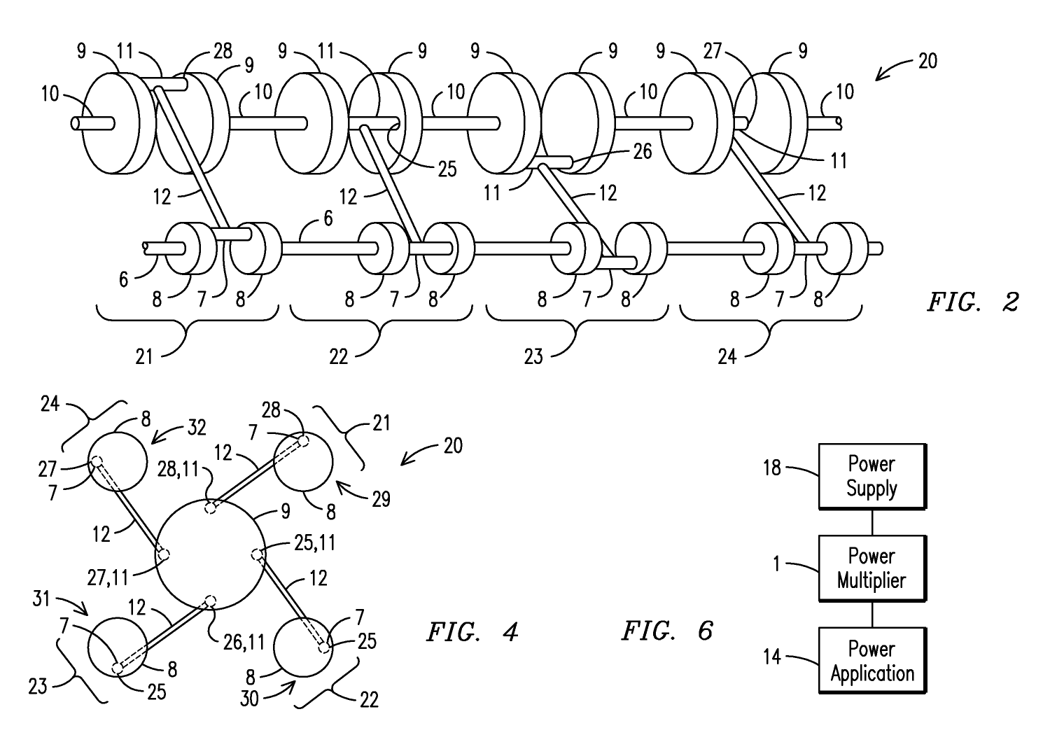

Now referring to FIG. 2, a side perspective view of a gear assembly 20 of a power multiplier 1 FIG. 1 showing the placement of off-set input axles 7, linkages 12 and off-set output axles 11 in relationship to each other. The gear assembly 20 is made up of four gear sets 21, 22, 23, 24, each having two input gears 8 affixed to each other by an off-set input axle 7, two output gears 9 affixed to each other by an off-set output axle 11 and a linkage 12 which connects the off-set input axle 7 to the off-set output axle 11 thereby allowing the input gears 8 to transfer rotational force to the output gears 9. The gear sets 21, 22, 23, 24 are connected to each other by central input axles 6 and central output axles 10. The placement of the off-set output axles 11 and off-set input axles 7 progressively differs by ninety degrees clockwise going from the first gear set 21 all the way to the fourth gear set 24. Therefore, if placement of the off-set output axle 11 and off-set input axle 7 is at a 360 degree position 28 in the first gear set 21, then the placement of the off-set output axle 11 and off-set input axle 7 will be at a ninety degree position 25 in the second gear set 22, the placement of the off-set output axle 11 and off-set input axle 7 will be at a 180 degree position 26 in the third gear set 23 and the placement of the off-set output axle 11 and off-set input axle 7 will be at a 270 degree position 27 in the fourth gear set 24. The placement of the of the off-set output axles 11 and off-set input axles 7 allows for an equal distribution of rotational force around the central output axles 10 as well as equal revolutions per minute (“RPM”) between the input gears 8 and the output gears 9. In addition, the output gears 9 have a larger diameter than the input gears 8. The difference in diameter of the output gears 9 and input gears 8 along with the placement of the of the off-set output axles 11 and off-set input axles 7 in relation to the central axles 6, 10 gives a mechanical advantage which allows for increased rotational force being applied to the central output axles 10 thereby creating more torque which thereby increases the horsepower of the power output from the power multiplier 1.

Now referring to FIG. 3, a side plan view of a power multiplier of the present invention having a satellite configuration is shown. The power multiplier 1 has a housing 2 which houses a gear assembly 20 made up of four gear sets 21, 22, 23 and 24. Each gear set 21, 22, 23, 24 has two input gears 8 affixed to each other by an off-set input axle 7, two output gears 9 affixed to each other by an off-set output axle 11 and a linkage 12 which connects the off-set input axle 7 to the off-set output axle 11. The linkage 12 allows the input gears 8 to transfer rotational force to the output gears 9. The input gears 8 of each gear set 21, 22, 23, 24 are not attached to each other by central input axles 6. Alternatively, the input gears 8 of each gear set 21, 22, 23, 24 surround the output gears 9 and are located at a 45 degree position 29, a 135 degree position 30, a 225 degree position 31 and a 315 degree position 32, respectively going around the output gears 9. Central input axles 6 and central output axles 10 pass through ball bearings 15 located in the housing 2.

At a proximal end 3 of the housing 2 central input axles 6 from each gear set 21, 22, 23, 24 and a central output axle 10 extend to the outside of the housing 2 through ball bearings 15. On the outside of the hosing 2, the central input axles 6 are attached to input intermeshing gears 16 which make contact with an output intermeshing gear 17 which is attached to the central output axle 10 to form a power input connection 5 which may be connected to a power source 19 such as a motor or engine. The power supplied by the power source 18 rotates the gear assembly 20.

At a distal end 4 of the housing 2 a central output axle 10 extends to the outside of the housing 2 through a ball bearing 15 to form a power output connection 13 which may be connected to a power application 14 such as machinery, generators which can power other devices and/or funnel energy back to the power source, or additional power multipliers to achieve additional energy output, and so forth.

Now referring to FIG. 4, a front plan view of a gear assembly 20 of a power multiplier 1 FIG. 3 showing the placement of off-set input axles 7, linkages 12 and off-set output axles 11 in relationship to each other is shown. The gear assembly is made up of four gear sets. Input gears 8 of the gear sets 21, 22, 23, 24 surround the output gears 9 and are located at a 45 degree position 29, a 135 degree position 30, a 225 degree position 31 and a 315 degree position 32, respectively going around the output gears.

The placement of the off-set output axles 11 and off-set input axles 7 progressively differs by ninety degrees clockwise going from the first gear set 21 all the way to the fourth gear set 24. Therefore, if placement of the off-set output axle 11 and off-set input axle 7 is at a 360 degree position 28 in the first gear set 21, then the placement of the off-set output axle 11 and off-set input axle 7 will be at a ninety degree position 25 in the second gear set 22, the placement of the off-set output axle 11 and off-set input axle 7 will be at a 180 degree position 26 in the third gear set 23 and the placement of the off-set output axle 11 and off-set input axle 7 will be at a 270 degree position 27 in the fourth gear set 24.

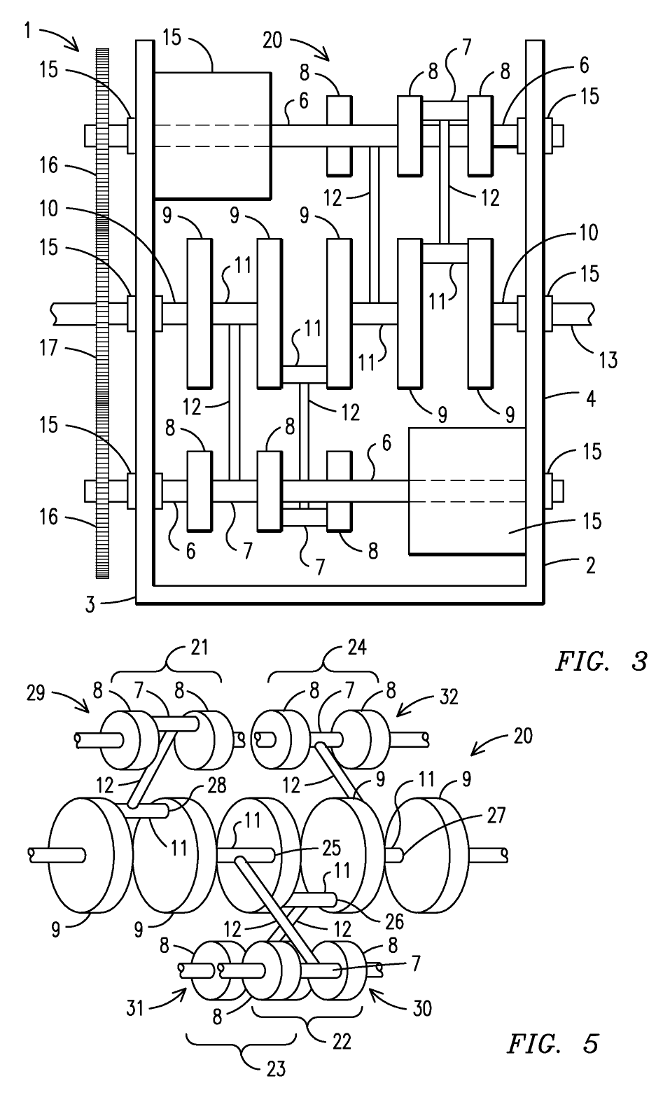

Now referring to FIG. 5, a side perspective view of a gear assembly 20 of a power multiplier 1 FIG. 3 showing the placement of off-set input axles 7, linkages 12 and off-set output axles 11 in relationship to each other is shown. The gear assembly is made up of four gear sets 21, 22, 23, 24 having input gears 8 which surround output gears 9 and are located at a 45 degree position 29, a 135 degree position 30, a 225 degree position 31 and a 315 degree position 32 respectively going around the output gears.

The placement of the off-set output axles 11 and off-set input axles 7 progressively differs by ninety degrees clockwise going from the first gear set 21 all the way to the fourth gear set 24. Therefore, if placement of the off-set output axle 11 and off-set input axle 7 is at a 360 degree position 28 in the first gear set 21, then the placement of the off-set output axle 11 and off-set input axle 7 will be at a ninety degree position 25 in the second gear set 22, the placement of the off-set output axle 11 and off-set input axle 7 will be at a 180 degree position 26 in the third gear set 23 and the placement of the off-set output axle 11 and off-set input axle 7 will be at a 270 degree position 27 in the fourth gear set 24.

Now referring to FIG. 6, a diagram showing a power multiplier 1 of the present invention in use is shown. First a power source 18, such as en engine or motor, is connected to the power multiplier 1. Then the power multiplier 1 is connected to a power application 14 such as machinery, generators which can power other devices and/or funnel energy back to the power source, or additional power multipliers to achieve additional energy output.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A power multiplier comprising:
a housing having a distal end and a proximal end;
an input connection for connecting the power multiplier to a power source;
a gear assembly which connects to the input connection, wherein the gear assembly comprises at least one gear set; and
an output connection, which connects to the gear assembly, for connecting the power multiplier to a power application.

2. The power multiplier of claim 1 wherein said at least on gear set comprises:
at least two input gears which are connected to each other by an off-set input axle and are connected to the housing by at least one central input axle;
at least two input gears which are connected to each other by an off-set output axle and are connected to the housing by at least one central output axle; and
at least one linkage which connects the off-set input axle to the off-set output axle.

3. The power multiplier of claim 1 further comprising:
at least one bearing located in the housing through which the gear assembly passes.

4. The power multiplier of claim 2 further comprising:
at least one bearing located in the housing through which the at least one central input axle passes; and
at least one bearing located in the housing through which the at least one central output axle passes.

5. The power multiplier of claim 1 further comprising:
at least one input intermeshing gear and at least one output intermeshing gear attached to the gear assembly.

6. The power multiplier of claim 2 further comprising:
at least one input intermeshing gear attached to the at least one central input axle; and
at least one output intermeshing gear attached to the at least the at least one central output axle.

7. The power multiplier of claim 1 wherein:
the gear assembly has a satellite configuration.

8. The power multiplier of claim 1 wherein:
the gear assembly has a lateral configuration.

9. The power multiplier of claim 2 wherein:
the gear assembly has a satellite configuration.

10. The power multiplier of claim 2 wherein:
the gear assembly has a lateral configuration.

11. A power multiplier comprising:
a housing having a distal end and a proximal end;
an input connection for connecting the power multiplier to a power source;
a gear assembly which connects to the input connection, wherein the gear assembly comprises at least one gear set having at least two output gears which are connected to each other by an off-set output axle and are connected to the housing by at least one central output axle and at least one linkage which connects the off-set input axle to the off-set output axle; and
an output connection, which connects to the gear assembly, for connecting the power multiplier to a power application.

12. The power multiplier of claim 11 further comprising:
at least one bearing located in the housing which the gear assembly passes through.

13. The power multiplier of claim 11 further comprising:
at least one bearing located in the housing through which the at least one central input axle passes; and
at least one bearing located in the housing through which the at least one central output axle passes.

14. The power multiplier of claim 11 further comprising:
at least one input intermeshing gear and at least one output intermeshing gear attached to the gear assembly.

15. The power multiplier of claim 11 further comprising:
at least one input intermeshing gear attached to the at least one central input axle; and
at least one output intermeshing gear attached to the at least the at least one central output axle.

16. The power multiplier of claim 11 wherein: the gear assembly has a satellite configuration.

17. The power multiplier of claim 11 wherein:
the gear assembly has a lateral configuration.
